(19) United States
(12) Patent Application Publication
(10) Pub. No.: US 2011/0187222 A1
(43) Pub. Date: Aug. 4, 2011

(54) DUAL-ROTOR MOTOR AND METHOD OF MANUFACTURING THE SAME

(75) Inventors: Hu Li, Osaka (JP); Yuichi Yoshikawa, Osaka (JP); Hiroshi Murakami, Osaka (JP); Hideaki Matsuo, Osaka (JP); Yuichiro Tashiro, Osaka (JP); Koichi Mitamura, Osaka (JP); Hideto Inoue, Osaka (JP); Reiji Tajima, Osaka (JP); Eiji Hataya, Osaka (JP)

(73) Assignee: Panasonic Corporation, Osaka (JP)

(21) Appl. No.: 12/738,848

(22) PCT Filed: Oct. 21, 2009
(86) PCT No.: PCT/JP2009/005511

§ 371 Date: Jun. 4, 2010

(30) Foreign Application Priority Data
Oct. 24, 2008 (JP) 2008-273798

(51) Int. Cl. H02K 1/18; H02K 15/00; H02K 1/14

(52) U.S. Cl. 310/216.016; 29/596; 310/216.086

(57) ABSTRACT

A dual-rotor motor provided with a stator having a stator core including a yoke, a plurality of teeth and a coil wound around the stator core, an inner rotor and an outer rotor, wherein the stator core includes an annular yoke component forming the yoke, and a plurality of tooth components forming the teeth. The stator core is made by fitting the tooth components individually into the annular yoke component in a manner that one ends of the tooth components protrude from the inner peripheral side of the annular yoke component and the other ends protrude from the outer peripheral side of the annular yoke component.

### TECHNICAL FIELD

The present invention relates to a dual-rotor motor provided with a rotor at both inside and outside of a stator, and more particularly to a motor having a stator core made of a combination of segmental components.

### BACKGROUND ART

There are some techniques heretofore made available, in which a stator core is made by combining segmental components prepared individually as separate pieces of the stator core. One example among those techniques hitherto disclosed is a method of separating a stator core into an annular yoke and a plurality of teeth (refer to patent literature 1, for instance). Also disclosed as another example is a method of separating a stator core into segmental pieces of a yoke configuration including a part of yoke and a tooth (refer to patent literature 2, for instance).

The methods of separating the stator core as disclosed in these literatures have such advantages as easing the process of winding coils around the stator core, and improving a space factor of the coils.

In the method of separating the stator disclosed in the patent literature 1, however, the teeth are extended in one direction and they cause weight balance of the teeth to shift to that direction of the yoke. This gives rise to a problem of lacking joining strength among the segmental components forming the teeth. In other words, the stator core is prone to become damaged such as the teeth being broken or bent at their joined root portions when they are subjected to external forces during the process of winding coils and the like. The method of separating the stator disclosed in the patent literature 2 also has the same problem of lacking the joining strength among the segmental components since the yoke has as many separate pieces as a number of the teeth thereby requiring many portions to be joined between the segmental yokes. That is, the joined portions of the segmental yokes are prone to become separated or cracked when they are subjected to external forces. There are also such other problems as needing an additional material for further reinforcement to ensure a sufficient joining strength among the segmental components.
Patent Literature 1: Japanese Patent Unexamined Publication, No. 2007-135331
Patent Literature 1: Japanese Patent Unexamined Publication, No. 2002-199666

### SUMMARY OF THE INVENTION

A dual-rotor motor of the present invention comprises a stator having a stator core including an annular yoke and a plurality of teeth, coils wound around the stator core, an outer rotor disposed around an outer peripheral side of the stator in a rotatable manner about a rotor shaft, and an inner rotor disposed to an inner peripheral side of the stator in a rotatable manner about the rotor shaft, wherein the stator core is made by combining a plurality of segmental components. The stator core comprises an annular yoke component as one of the segmental components to form the yoke, and a plurality of tooth components as others of the segmental components to form the teeth. The stator core is made with the tooth components fitted individually into the annular yoke component in a manner that one ends of the tooth components protrude from the inner peripheral side of the annular yoke component and the other ends protrude from the outer peripheral side of the annular yoke component.

Since the above structure has the individual tooth components fitted in the manner to protrude from both the inner peripheral side and the outer peripheral side of the annular yoke component, it ensures steadiness of keeping weight balance of the tooth components in relation to the annular yoke component. It can hence make the teeth not readily become broken, bent, separated or cracked even when they receive external forces. In addition, the steadiness of keeping the weight balance eliminates the need to provide any complex reinforcing structure, thereby making an improvement possible of the manufacturing efficiency.

Furthermore, the dual-rotor motor of the present invention has the annular yoke component and the tooth components of integrated structures, each made by stacking a plurality of sheet-like plates.

Such structures can improve a utilization ratio of the steel material.

A method of manufacturing a dual-rotor motor of the present invention is the manufacturing method of the dual-rotor motor comprising a stator having a stator core including an annular yoke and a plurality of teeth, coils wound around the stator core, an outer rotor disposed around an outer peripheral side of the stator in a rotatable manner about a rotor shaft, and an inner rotor disposed to an inner peripheral side of the stator in a rotatable manner about the rotor shaft, wherein the stator core is made by combining a plurality of segmental components. This manufacturing method comprises a step of making a yoke component by stacking a plurality of sheet-like plates of different shapes, a step of making tooth components by stacking a plurality of sheet-like plates of different shapes, and a step of fitting the tooth components individually into the yoke component in a manner that one ends of the tooth components protrude from the inner peripheral side of the yoke component, and the other ends protrude from the outer peripheral side of the yoke component.

Since the above method enables the individual tooth components fitted in the manner to protrude from both the inner peripheral side and the outer peripheral side of the yoke component, it ensures steadiness of keeping weight balance of the tooth components relative to the yoke component. In addition, the steadiness of keeping the weight balance eliminates the need to provide any complex reinforcing structure, thereby making an improvement possible of the manufacturing efficiency.

### BRIEF DESCRIPTION OF DRAWINGS

FIG. 1 is a schematic drawing showing sectioned view of a dual-rotor motor according to an exemplary embodiment of the present invention;

FIG. 2 is a perspective view of a stator core of the dual-rotor motor;

FIG. 3 is a perspective view showing a combination of a yoke component and a tooth component constituting the stator core of the dual-rotor motor;

FIG. 4 is a perspective view showing a segmental stator core of the dual-rotor motor;

FIG. 5A is a plan view showing individual sheet-like plates composing the yoke component of the dual-rotor motor;

FIG. 5B is a plan view showing individual sheet-like plates composing the tooth component of the dual-rotor motor;

FIG. 6A is a perspective view showing a yoke base component and a yoke stack component of the dual-rotor motor;

FIG. 6B is a perspective view showing the yoke component composed by using the yoke base component and the yoke stack components of the dual-rotor motor;

FIG. 7A is a plan view showing a band metallic material for die-cutting yoke base plates of the dual-rotor motor;

FIG. 7B is a plan view showing another band metallic material for die-cutting yoke stack plates of the dual-rotor motor;

FIG. 8A is a perspective view showing tooth base component and two kinds of tooth stack components of the dual-rotor motor;

FIG. 8B is a perspective view showing the tooth component composed by using the tooth base component and the two kinds of tooth stack components of the dual-rotor motor;

FIG. 9A is a plan view showing a band metallic material for die-cutting tooth base plates of the dual-rotor motor;

FIG. 9B is a plan view showing another band metallic material for die-cutting one kind of tooth stack plates of the dual-rotor motor; and

FIG. 9C is a plan view showing still another band metallic material for die-cutting another kind of tooth stack plates of the dual-rotor motor.

### DETAILED DESCRIPTION OF PREFERRED EMBODIMENT

Description will be provided hereinafter of an exemplary embodiment of the present invention with reference to the accompanying drawings.

### Exemplary Embodiment

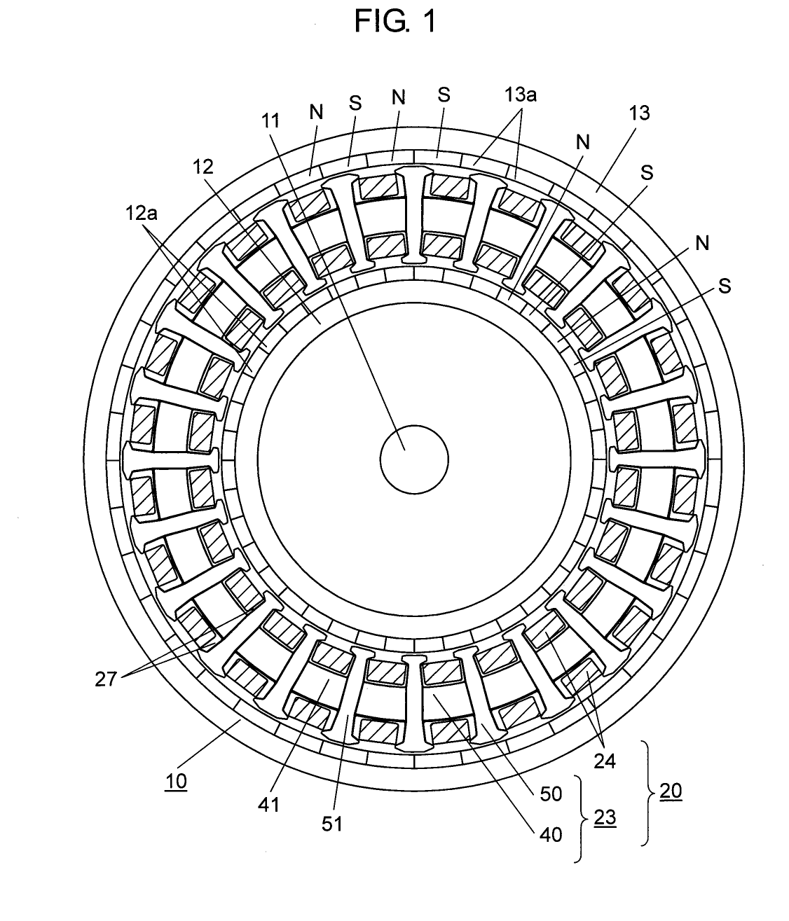

FIG. 1 is a schematic drawing showing a sectioned view of dual-rotor motor 10 according to this exemplary embodiment of the invention. FIG. 1 shows the sectioned view as observed in a longitudinal direction of a rotor shaft.

As shown in FIG. 1, dual-rotor motor 10 according to this exemplary embodiment comprises stator 20, inner rotor 12 and outer rotor 13. Stator 20 has coils 24 wound around stator core 23. Inner rotor 12 is disposed to an inner peripheral side of stator 20 in a rotatable manner, and outer rotor 13 is disposed around an outer peripheral side of stator 20 in a rotatable manner.

Stator core 23 includes annular yoke 40 and a plurality of teeth 50 that protrude from both the inner peripheral side and the outer peripheral side of yoke 40. There are void spaces defined as slots 27, each formed between adjoining teeth 50 at both the inner peripheral side and the outer peripheral side of yoke 40, and coils 24 are wound around yoke 40 by using these void spaces of slots 27.

Stator core 23 of this exemplary embodiment is made by combining segmental components of a plurality of kinds prepared as separated pieces of stator core 23, as will be described hereinafter in details. The segmental components include a plural variety of separated pieces ranging from a smaller component to a larger component. In other words, stator core 23 is made by combining annular yoke component 41 and a plurality of tooth components 51, as shown in FIG. 1. Annular yoke component 41 is an annularly-shaped segmental component that forms yoke 40. Tooth component 51 is a segmental component that forms tooth 50. Annular yoke component 41 and tooth components 51 further comprise separated smaller components, details of which will be described in a latter part.

Tooth components 51 have their one ends protruding from the inner peripheral side of annular yoke component 41, and the other ends protruding from the outer peripheral side of annular yoke component 41, as shown in FIG. 1. That is, stator core 23 is made by fitting individual tooth components 51 into annular yoke component 41 in a manner so that their one ends protrude from the inner peripheral side and the other ends protrude from the outer peripheral side of annular yoke component 41. Each of tooth components 51 is assembled with annular yoke component 41 and fitted together in a manner to cross with each other. The individual tooth components 51 are thus disposed to annular yoke component 41 at predetermined intervals along a circumferential direction thereof.

Inner rotor 12 is provided with a plurality of permanent magnets 12a fixed to the outer periphery thereof with the S poles and the N poles arranged alternately. Inner rotor 12 is disposed in a position to confront the inner peripheral side of teeth 50 with a predetermined gap. Outer rotor 13 is provided with a plurality of permanent magnets 13a fixed to the inner periphery thereof with S poles and N poles arranged alternately. Outer rotor 13 is disposed in a position to confront the outer peripheral side of teeth 50 with a predetermined gap. Both inner rotor 12 and outer rotor 13 are coupled to rotor shaft 11 and so retained as to be rotatable about rotor shaft 11 in the circumferential direction of the confronting stator 20. Any of inner rotor 12 and outer rotor 13 may have such a structure provided with an annular magnet of cylindrical shape having S poles and N poles alternately along the circumferential direction.

In the structure discussed above, when ac power is applied to coils 24 of stator 20, it produces magnetic attractive forces and repulsive forces between inner rotor 12 and the inner peripheral ends of teeth 50, and also between outer rotor 13 and the outer peripheral ends of teeth 50. These attractive forces and repulsive forces cause inner rotor 12 and outer rotor 13 to rotate about rotor shaft 11. It becomes possible to obtain a high torque with a small size especially by virtue of the dual-rotor structure equipped with the rotors at both the inside and outside of stator 20 as shown in this exemplary embodiment

Description is provided next of the detailed structure of stator core 23 according to this exemplary embodiment.

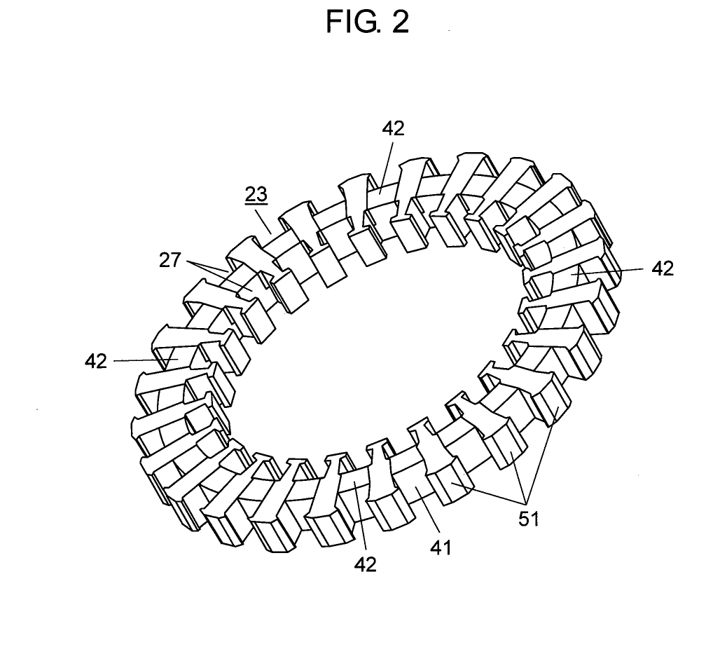

FIG. 2 is a perspective view of stator core 23 of dual-rotor motor 10 in this exemplary embodiment of the invention. The description provided herein focuses mainly on the individual segmental components that compose stator core 23.

As shown in FIG. 2, stator core 23 is made by combining annular yoke component 41 and a plurality of tooth components 51. In order to compose such a structure as above, annular yoke component 41 is provided with recessed portions in one of annular surfaces at predetermined intervals along the circumferential direction. Tooth components 51 are each provided with a recessed portion in the center thereof. Stator core 23 is thus made by engaging the recessed portions of the individual tooth components 51 with the recessed portions of annular yoke component 41.

Furthermore, annular yoke component 41 comprises a plurality of yoke components 42 of a circular arc shape in a separate form of yoke 40. That is, annular yoke component 41 is made by combining a plural piece of such yoke components 42. This exemplary embodiment represents one example, in which yoke 40 comprises four identically-shaped yoke components 42, five tooth components 51 are fitted into each one of yoke components 42, and one tooth component 51 is fitted into each of joining portions between the adjoining yoke components 42.

Described next is a method of joining individual yoke components 42 and also between yoke component 42 and tooth components 51.

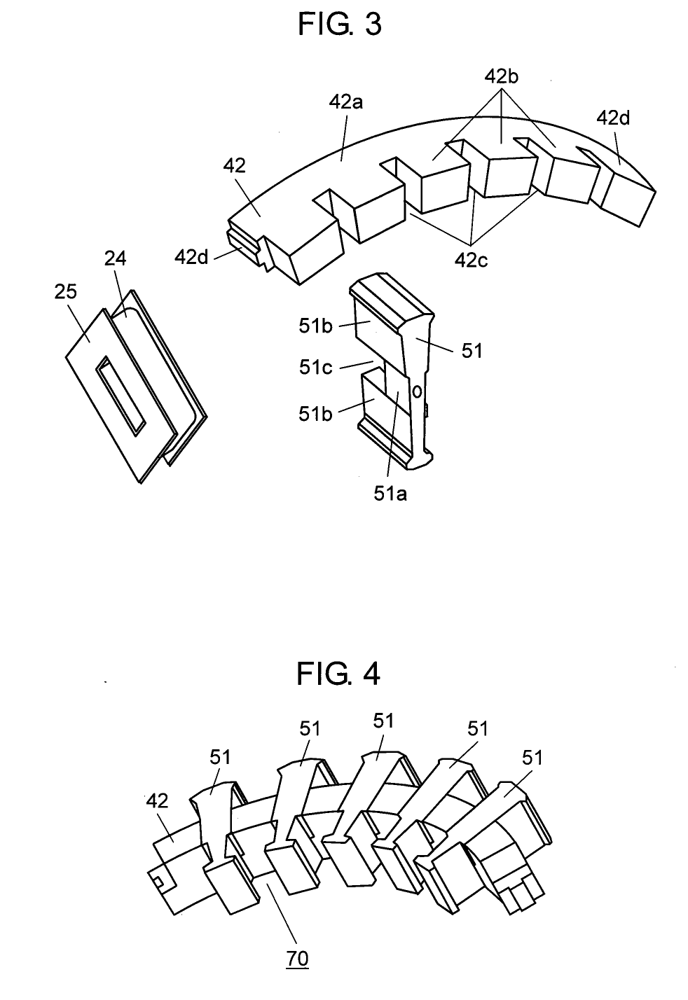

FIG. 3 is a perspective view showing the combination of yoke component 42 and tooth component 51 that constitute stator core 23.

As shown in FIG. 3, yoke component 42 is provided with a plurality of stack portions and recessed portions alternately at predetermined intervals along the circumferential direction on one of its arc surfaces. FIG. 3 shows one example in which yoke component 42 has six yoke stack portions 42b extending from one of the arc surfaces of arc-shaped yoke base portion 42a at equal intervals, so that five yoke recessed portions 42c are formed between them. Yoke component 42 is also provided with yoke joining portions 42d formed at both ends of arc-shaped yoke base portion 42a. Annular yoke component 41 is made by joining individual yoke components 42 at these yoke joining portions 42d. When individual yoke components 42 are joined at yoke joining portions 42d, additional yoke recessed portions 42c similar to the originally provided yoke recessed portions 42c are formed between these yoke joining portions 42d.

On the other hand, tooth component 51 is provided with a recessed portion near the center area of one of the sides parallel to the longitudinal direction thereof. FIG. 3 shows one example in which two tooth stack portions 51b of different shapes extend from tooth base portion 51a with a space separating between them. Tooth recessed portion 51c is thus formed between one of tooth stack portions 51b constituting a part of the outer peripheral side of tooth 50 and the other tooth stack portion 51b constituting a part of the inner peripheral side of tooth 50.

Yoke component 42 and tooth component 51 have the structures illustrated above, so that a segmental stator core constituting one quarter of stator core 23 is made by engaging tooth recessed portions 51c of tooth components 51 individually to each of yoke recessed portions 42c of yoke component 42. FIG. 4 shows segmental stator core 70 composed in this manner.

In this method of manufacturing dual-rotor motor 10, it is desirable to take the following steps as concrete steps of manufacturing stator core 23. FIG. 3 also shows an example of a coil to be wound on stator core 23. The description provided here therefore covers a typical example of making coil winding, in which coil 24 wound on bobbin 25 is installed on stator core 23.

First, tooth recessed portion 51c of tooth component 51 is fitted into yoke recessed portion 42c near one end of yoke component 42. Next, bobbin 25 is inserted from the other end of yoke component 42 and positioned on yoke stack portion 42b next to where tooth recessed portion 51c is fitted. Tooth recessed portion 51c of another tooth component 51 is then fitted into yoke recessed portion 42c second from the one end of yoke component 42. These steps form slots 27 at both inner peripheral side and outer peripheral side surrounded by the two fitted pieces of tooth components 51 and yoke stack portion 42b, and coil 24 wound on bobbin 25 is set in slots 27. Another bobbin 25 is then inserted from the other end of yoke component 42 and positioned on yoke stack portion 42b next to where tooth recessed portion 51c is fitted. The above steps are repeated to set tooth components 51 and bobbins 25 alternately from the one end to the other end of yoke component 42 so as to complete segmental stator core 70 having coils 24 wound on it. It becomes possible to improve the efficiency of coil-winding process and a space factor of the coils especially when the above manufacturing steps are used since they can eliminate the need of taking complex processes of winding coils in the slots between fully assembled teeth, which also decreases the space factor of the coils.

In the next step, segmental stator cores 70 having coils 24 are joined together at their yoke joining portions 42d. Additional tooth components 51 are then fitted individually by engaging their tooth recessed portions 51c into yoke recessed portions 42c formed between yoke joining portions 42d of joined yoke components 42. These steps complete stator core 23 provided with tooth components 51 fitted in annular yoke component 41 at predetermined intervals along the circumferential direction and in the manner to protrude from the inner peripheral side and the outer peripheral side of annular yoke component 41. By following the above manufacturing steps, in particular, stator core 23 can be provided with coils 24 wound on it, thereby completing stator 20.

As described above, stator core 23 of dual-rotor motor 10 has a structure, wherein the individual tooth components 51 are fitted in annular yoke component 41 at the predetermined intervals along the circumferential direction and in the manner that their one ends protrude from the inner peripheral side and the other ends protrude from the outer peripheral side of annular yoke component 41. The structure constructed as above makes annular yoke component 41 support individual tooth components 51 near their center portions as the fulcra, thereby holding the individual tooth components 51 with their weights balanced stably on annular yoke component 41. Since this structure can keep individual tooth components 51 joined in the well-balanced manner on annular yoke component 41 with robustness against their weights and external forces, it can ensure a sufficient strength of the stator core with the simple structure.

Annular yoke component 41 is provided with a plurality of yoke recessed portions 42c in one of the annular surfaces at predetermined intervals along the circumferential direction, and tooth components 51 are each provided with tooth recessed portion 51c in the center thereof. Stator core 23 is thus made by fitting tooth recessed portions 51c one after another into yoke recessed portions 42c. In other words, yoke component 42 and tooth components 51 are joined with each other in such a manner that the center portions of tooth base portions 51a are placed between yoke stack portions 42b, and yoke base portion 42a is placed between tooth stack portions 51b. Since yoke recessed portions 42c and tooth recessed portions 51c are joined into a recess-to-recess engagement of crisscross orientation, this simple structure can ensure the sufficient joining strength.

This structure has yoke recessed portions 42c formed in yoke joining portions 42d joined together, and tooth recessed portions 51c are also fitted in these yoke recessed portions 42c. The structure composed as above thus has tooth recessed portions 51c joined in the manner to make crisscross engagement with yoke joining portions 42d where the joining strength of stator core 23 is relatively weak. However, tooth recessed portions 51c joined in these portions have the effect of reinforcing the strength of yoke joining portions 42d. This structure thus ensures the robustness as an integrated structure of stator core 23.

Although what has been described above is the example, in which tooth recessed portions 51c are formed in the center area of tooth components 51 to fit in yoke recessed portions 42c, tooth recessed portions 51c need not be formed in the center area of tooth components 51. In the dual-rotor motor, the teeth of the outer peripheral side are normally formed larger than the teeth of the inner peripheral side, and they are therefore heavier. However, the position of the teeth recessed portions may be shifted off center, for instance, to make the teeth become generally equal in their weights between the outer peripheral side and the inner peripheral side. In this way, tooth components 51 have their weights supported well-balanced between the outer peripheral side and the inner peripheral side, and they thus become stable.

Description is provided next in more details of the structure of the individual segmental components according to this exemplary embodiment.

The above-discussed individual segmental components that compose stator core 23, i.e., yoke components 42 and tooth components 51, are formed by stacking sheet-like plates made by die-cutting out of a metallic plate such as a silicon steel sheet.

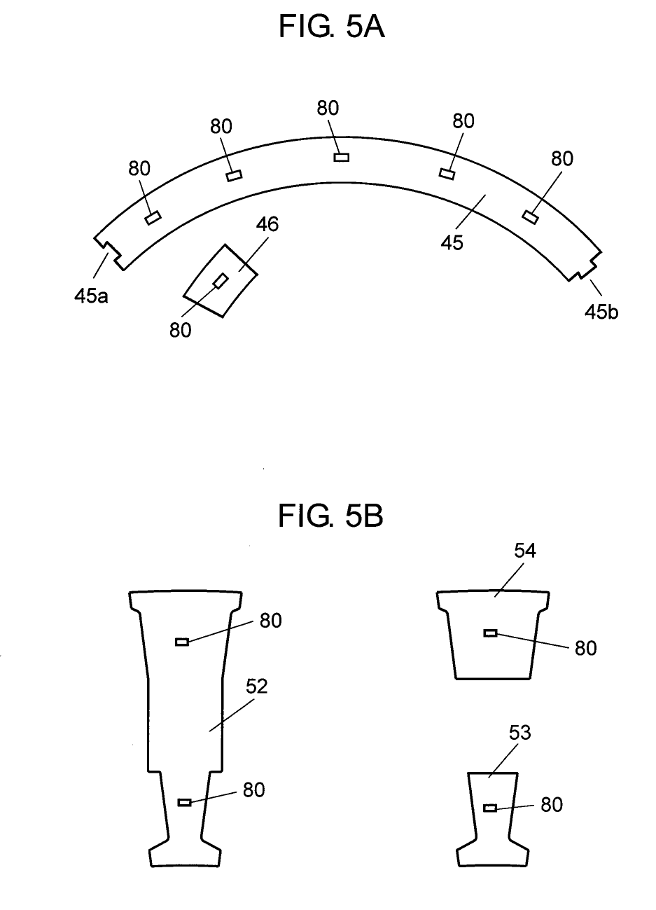

FIG. 5A is a plan view showing the individual sheet-like plates used for making yoke component 42. FIG. 5A shows yoke base plate 45 and yoke stack plate 46, which are two kinds of the sheet-like plates to form yoke component 42. FIG. 5B, on the other hand, is a plan view showing the individual sheet-like plates used for making tooth component 51. FIG. 5B shows tooth base plate 52, tooth stack plates 53 and 54, which are three kinds of the sheet-like plates to form tooth component 51. Tooth stack plate 53 composes a part of the inner peripheral side of tooth 50, and tooth stack plate 54 composes a part of the outer peripheral side of tooth 50.

The individual sheet-like plates have swaging portions 80 formed in the positions shown in FIGS. 5A and 5B. Each of swaging portions 80 includes a combination of small nib and small dimple formed on the individual sheet-like plates used for swaging them together, such as a countersink having a small nib on one surface of the sheet-like plate and a small dimple in the other surface in a position corresponding to the nib. As shown, each of the sheet-like plates is provided with at least one swaging portion 80 having a small nib on one surface and a small dimple in the other surface. A plurality of the sheet-like plates are stacked with their nibs and dimples aligned to fit with one another, and swaging portions 80 are swaged by pressing the stacked plates from the both surfaces thereof. The individual segmental components consisting of the stacked sheet-like plates are thus formed. Each of yoke base plates 45 has yoke joining recess 45a of a concave shape opened in the circumferential direction at one of its circumferential ends and yoke joining protrusion 45b of a convex shape projecting in the circumferential direction at the other circumferential end for interconnection of yoke components 42, as shown in FIG. 5A.

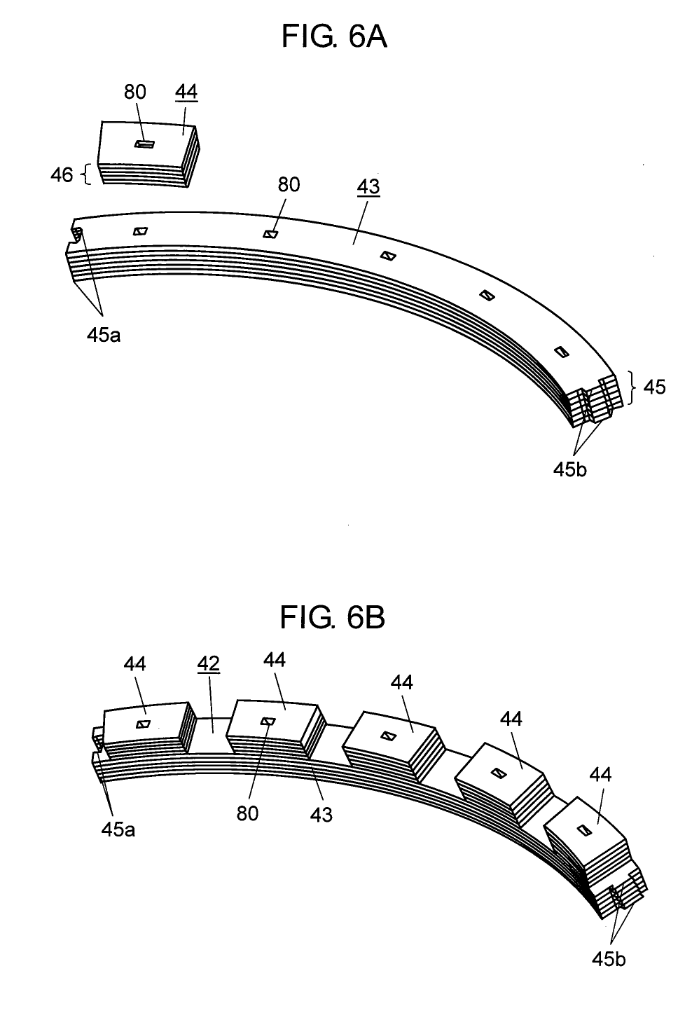

Shown next in FIG. 6A is a perspective view of yoke base component 43 and yoke stack component 44. Yoke base component 43 has a structure composed of stacked yoke base plates 45 as shown in FIG. 6A, and it makes up yoke base portion 42a shown in FIG. 3. Yoke stack component 44 has a structure composed of stacked yoke stack plates 46, and it makes up yoke stack portion 42b shown in FIG. 3. FIG. 6B is a perspective view showing yoke component 42 composed by using yoke base component 43 and yoke stack components 44. As shown in FIG. 6B, yoke component 42 has a structure comprising a plurality of yoke stack components 44 stacked on yoke base component 43.

York base component 43 is made by stacking a plurality of yoke base plates 45 as shown in FIG. 6A, and pressing the stacked yoke base plates 45 from the both surfaces. On the other hand, yoke stack component 44 is made by stacking a plurality of yoke stack plates 46 and pressing the stacked yoke stack plates 46 from the both surfaces. Furthermore, yoke component 42 shown in FIG. 6B is made by aligning swaging portions 80 of yoke stack components 44 with swaging portions 80 of yoke base component 43 and pressing them together. Alternatively, yoke component 42 may be made by stacking the plurality of yoke base plates 45 and the plurality of yoke stack components 45 with their swaging portions 80 aligned individually, and by pressing all of these sheet-like plates at once. Moreover, a plurality of yoke components 42 are assembled in a manner that yoke joining recess 45a at one end of one of yoke component 42 is engaged with yoke joining protrusion 45b at one end of another yoke component 42. Annular yoke component 41 is thus composed by connecting the plurality of yoke components 42 into an annular configuration.

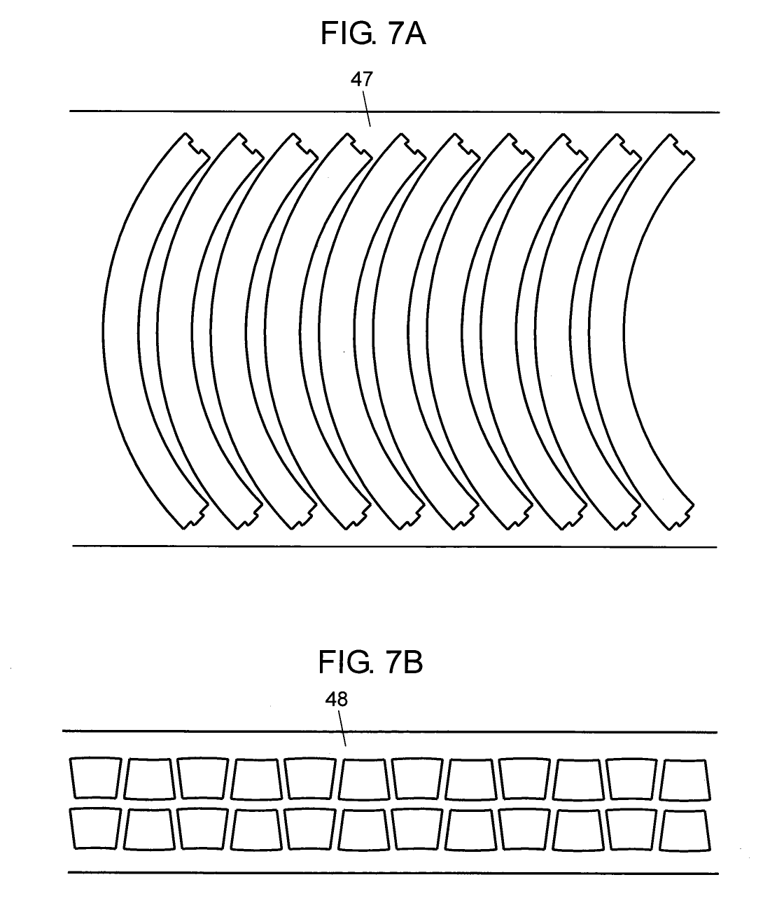

FIG. 7A is a plan view showing band metallic material 47 for die-cutting yoke base plates 45, and FIG. 7B is a plan view showing another band metallic material 48 for die-cutting yoke stack plates 46.

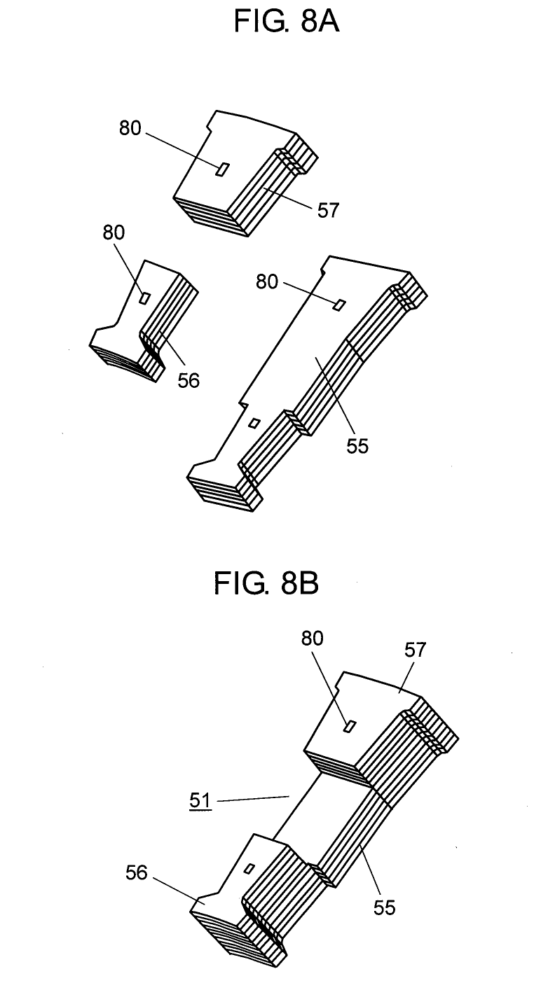

FIG. 8A shown next is a perspective view of tooth base component 55, tooth stack component 56 and another tooth stack component 57. Tooth base component 55 has a structure comprising stacked tooth base plates 52 as shown in FIG. 8A, and it makes up tooth base portion 51a shown in FIG. 3. Tooth stack component 56 has a structure comprising stacked tooth stack plates 53, and it makes up tooth stack portion 51b shown in FIG. 3. Tooth stack component 57 has a structure comprising stacked tooth stack plates 54, and it makes up another tooth stack portion 51b shown in FIG. 3. FIG. 8B is a perspective view showing tooth component 51 made by using tooth base component 55, tooth stack component 56 and tooth stack component 57.

Tooth base component 55 is made by stacking a plurality of tooth base plates 52 as shown in FIG. 8A, and pressing the stacked tooth base plates 52 from the both surfaces. On the other hand, tooth stack component 56 is made by stacking a plurality of tooth stack plates 53 and pressing the stacked tooth stack plates 53 from the both surfaces. Likewise, tooth stack component 57 is made by stacking a plurality of tooth stack plates 54 and pressing the stacked tooth stack plates 54 from the both surfaces. Furthermore, swaging portion 80 of tooth stack component 56 is aligned to swaging portion 80 at one side of tooth base component 55, swaging portion 80 of tooth stack component 57 is aligned to swaging portion 80 at another side of tooth base component 55, and they are pressed together. This process composes tooth component 51 shown in FIG. 8B. Alternatively, tooth component 51 may be made by stacking the plurality of tooth base plates 52 and a plurality of tooth stack components 56 as well as a plurality of tooth stack components 56 with their swaging portions 80 aligned individually, and by pressing all of these sheet-like plates at once.

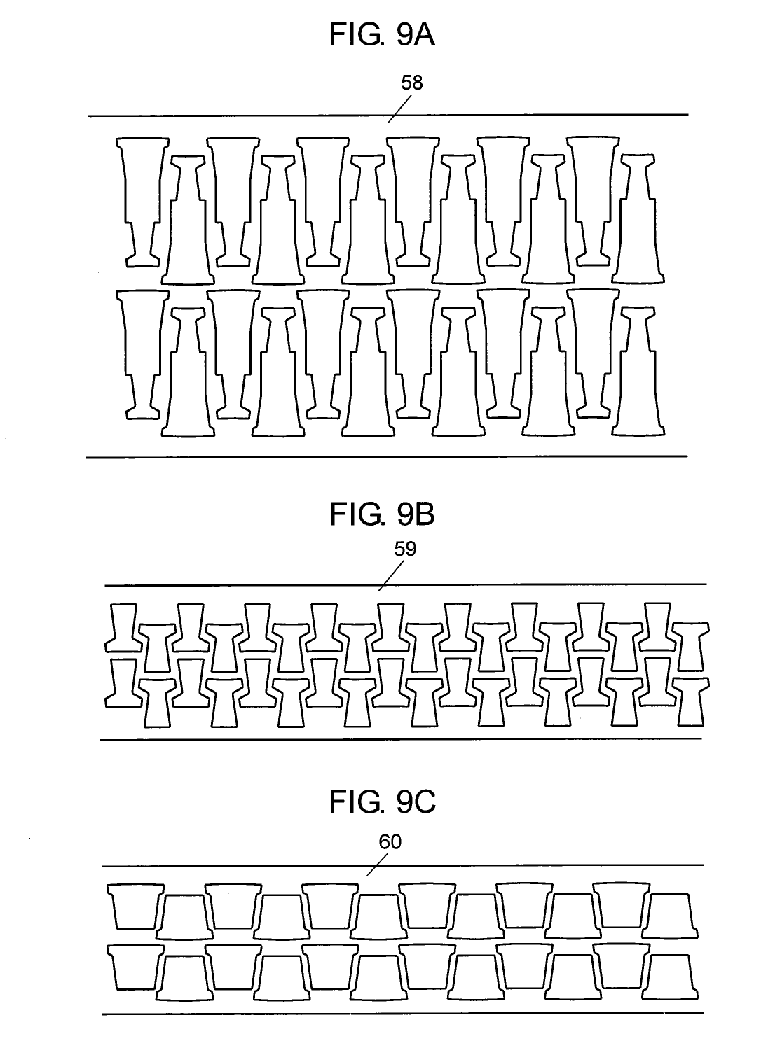

FIG. 9A is a plan view showing band metallic material 58 for die-cutting tooth base plates 52, FIG. 9B is a plan view showing another band metallic material 59 for die-cutting tooth stack plates 53, and FIG. 9C is a plan view showing still another band metallic material 60 for die-cutting tooth stack plates 54.

According to the present exemplary embodiment, the individual segmental components are composed by using the sheet-like plates die-cut from the band metallic materials into the shapes of the corresponding segmental components as shown in FIGS. 7A, 7B and FIGS. 9A, 9B and 9C. If on the other hand, the stator core is formed by die-cutting a metallic material into a solid piece of the annular yoke shape including the teeth, for instance, unusable portions of the metallic material increase such as the areas inside the annular yoke, which lowers an utilization efficiency of the material. In comparison to the above, the technique of forming the stator core by combining the segmental components can make the individual segmental components smaller and simpler in their sizes and shapes than that of the stator core. It can thus increase an areal ratio of utilizing the metallic material as is obvious from FIGS. 7A, 7B and FIGS. 9A, 9B and 9C. In other words, it becomes possible according to the present exemplary embodiment to improve the utilization efficiency of the material by virtue of the technique that the stator core is made by combining a plurality of different kinds of segmental components made into separate forms, wherein the segmental components include a plural variety of separated pieces ranging from a smaller component to a larger component.

According to the dual-rotor motor and the method of manufacturing the same of the present invention, the individual tooth components are fitted to the annular yoke component in the manner to protrude from both the inner peripheral side and the outer peripheral side thereof as illustrated above. The individual tooth components are hence kept joined in a well-balanced manner with robustness against their weights and external forces. Accordingly, the present invention can provide the dual-rotor motor of the simple structure while ensuring the sufficient strength of the stator core, as well as the method of manufacturing the same.

Although what has been described above is an example, in which the individual segmental components are formed by stacking the sheet-like plates, the segmental components such as the yoke component and the tooth components may be formed of magnetic iron powder by means of press-forming.

### INDUSTRIAL APPLICABILITY

The dual-rotor motor and the method of manufacturing the same of the present invention can ensure sufficient strength of the stator core with the simple structure, and it is therefore suitable as a dual-rotor motor requiring a high power, high efficiency, low noise and low cost for use in a home appliance and the like electrical product.

### REFERENCE MARKS IN THE DRAWINGS

10 Dual-rotor motor
11 Rotor shaft
12 Inner rotor
12a, 13a Permanent magnet
13 Outer rotor
20 Stator
23 Stator core
25 Bobbin
27 Slot
40 Yoke
41 Annular yoke component
42 Yoke component
42a Yoke base portion
42b Yoke stack portion
42c Yoke recessed portion
42d Yoke joining portion
43 Yoke base component
44 Yoke stack component
45 Yoke base plate
45a Yoke joining recess
45b Yoke joining protrusion
46 Yoke stack plate
47, 48, 58, 59, 60 Band metallic material
50 Tooth/Teeth
51 Tooth component
51a Tooth base portion
51b Tooth stack portion
51c Tooth recessed portion
52 Tooth base plate
53, 54 Tooth stack plate
55 Tooth base component
56, 57 Tooth stack component
70 Segmental stator core

1. A dual-rotor motor comprising:
a stator having a stator core including an annular yoke and a plurality of teeth, and a coil wound around the stator core;
an inner rotor disposed to an inner peripheral side of the stator in a rotatable manner about a rotor shaft; and
an outer rotor disposed around an outer peripheral side of the stator in a rotatable manner about the rotor shaft, wherein
the stator core is made by combining a plurality of segmental components, and further wherein:
the stator core comprises an annular yoke component as one of the segmental components forming the yoke, and a plurality of tooth components as others of the segmental components forming the teeth;
the stator core is formed by fitting the tooth components individually into the annular yoke component in a manner that one ends of the tooth components protrude from the inner peripheral side of the annular yoke component, and the other ends protrude from the outer peripheral side of the annular yoke component.

2. The dual-rotor motor of claim 1, wherein:
the annular yoke component is provided with a plurality of recessed portions in one of the annular surfaces at predetermined intervals in a circumferential direction;
the tooth components are each provided with a recessed portion in the center thereof, and
the stator core is formed by fitting the recessed portion of the individual tooth components into each of the recessed portions of the annular yoke component.

3. The dual-rotor motor of claim 2, wherein the segmental components include a plurality of yoke components having a circular arc shape, and the annular yoke component is made by combining the yoke components.

4. The dual-rotor motor of claim 3, wherein the stator core is made by fitting the tooth components into the yoke components, and additional tooth component into a joined portion of the yoke components.

5. The dual-rotor motor of claim 3, wherein each of the yoke components further comprises a yoke base component of a circular arc shape as one of the segmental components, and a plurality of yoke stack components as some of the segmental components disposed in a circumferential direction on one of circular arc surfaces of the yoke base component.

6. The dual-rotor motor of claim 2, wherein each of the tooth components further comprises a tooth base component as one of the segmental components, and two different kinds of tooth stack components as two of the segmental components disposed on both ends of the tooth base component.

7. The dual-rotor motor of claim 3, wherein:
each of the yoke components further comprises a yoke base component of a circular arc shape as one of the segmental components, and a plurality of yoke stack components as some of the segmental components disposed in a circumferential direction on one of circular arc surfaces of the yoke base component;
each of the tooth components further comprises a tooth base component as one of the segmental components, and two different kinds of tooth stack components as two of the segmental components disposed on both ends of the tooth base component; and
each of the yoke base component, the yoke stack component, the tooth base component and the tooth stack component is made by stacking a plurality of sheet-like plates into an integrated structure.

8. The dual-rotor motor of claim 7, wherein each of the sheet-like plates has at least one small nib-and-dimple combination including a small nib on one of surfaces thereof and a small dimple in the other surface in a position corresponding to the nib, and each of the yoke base component, the yoke stack component, the tooth base component and the tooth stack component is made by swaging together the small nib and the small dimple.

9. The dual-rotor motor of claim 8, wherein:
the yoke component is made by swaging the small nib and dimple on each of the plurality of yoke stack components together with the small nib and dimple of the yoke base component; and
the tooth component is made by swaging the small nib and dimple on each of the two kinds of tooth stack components together with the small nib and dimple on the tooth base component.

10. The dual-rotor motor of claim 1, wherein each of the annular yoke component and the tooth components is made by stacking a plurality of sheet-like plates into an integrated structure.

11. A method of manufacturing a dual-rotor motor comprising a stator having a stator core including an annular yoke and a plurality of teeth, a coil wound around the stator core, an outer rotor disposed to an outer peripheral side of the stator in a rotatable manner about a rotor shaft, and an inner rotor disposed around an inner peripheral side of the stator in a rotatable manner about the rotor shaft, wherein the stator core is made by combining a plurality of segmental components,
the method comprising:
a step of making a yoke component by stacking a plurality of sheet-like plates of different shapes;
a step of making tooth components by stacking a plurality of sheet-like plates of different shapes; and
a step of fitting the tooth components individually into the yoke component in a manner that one ends of the tooth components protrude from the inner peripheral side of the yoke component and the other ends protrude from the outer peripheral side of the yoke component.
